(19) United States
(12) Patent Application Publication
(10) Pub. No.: US 2017/0171530 A1
(43) Pub. Date: Jun. 15, 2017

(54) SCANNING PLATFORMS WITH ADHESION PROMOTING COMPOUNDS

(71) Applicant: Hewlett-Packard Development Company, L.P., Fort Collins, CO (US)

(72) Inventors: Matthew G. Lopez, San Diego, CA (US); Kai-Kong Iu, San Diego, CA (US); Hsing Ming Chin, San Diego, CA (US)

(21) Appl. No.: 14/970,248

(22) Filed: Dec. 15, 2015

(51) Int. Cl. H04N 13/02; G06T 7/00; B05D 3/00

(52) U.S. Cl. CPC H04N 13/0275; B05D 3/007; G06T 7/0057; H04N 2213/001

(57) ABSTRACT

The present disclosure is drawn to scanning platforms. For example, a scanning platform can include an upper portion formed of a silicone polymer. The upper portion can include an upper surface that is chemically activated by a corona treatment. A layer of adhesion promoting compound can be bonded to the upper surface. The adhesion promoting compound can include a glycol, glycol ether, or combinations thereof.

### BACKGROUND

Advances in digital technologies have created uses for digital 3-dimensional models for a wide variety of applications. 3-dimensional modelling is used in fields such as computer-aided design (CAD), rapid prototyping, aerodynamic and fluid dynamic modelling, animation, software, and many others. For several years, digital 3-dimensional models have been created manually by designers using software such as CAD software, 3-dimensional sculpting software, and so on. Recently, some progress has been made in the field of 3-dimensional scanning. 3-dimensional scanning can allow objects from the real world to be converted into digital 3-dimensional models. This is useful for application involving real world objects, such as reverse engineering, rapid prototyping, scanning the human body to aid in making orthotics and prosthetics, and so on.

### BRIEF DESCRIPTION OF THE DRAWINGS

FIG. 1A is a side view of a scanning platform according to an example;

FIG. 1B is a perspective view of a scanning platform according to an example;

FIG. 2A is a side view of a scanning platform according to an example;

FIG. 2B is a perspective view of a scanning platform according to an example;

FIG. 3 is a schematic of a system according to an example; and

FIG. 4 is a flow chart of a method of providing adhesion to a scanning platform according to an example.

### DETAILED DESCRIPTION

Various 3-dimensional scanning technologies that have been developed include contact scanners that physically contact surfaces of an object to be scanned, as well as non-contact scanners that image an object to be scanned using light, lasers, infrared radiation, x-ray radiation, and ultrasound, among other methods. One method of 3-dimensional scanning involves using visible light cameras, and in some cases, infrared cameras. The images formed by the imaging cameras can be combined and analyzed using software to form a 3-dimensional model of the object being scanned.

The present disclosure is drawn to scanning platforms, methods of providing adhesion to scanning platforms, and systems including the scanning platforms. In some methods of 3-dimensional scanning, an object to be scanned can be rotated and/or tilted to facilitate forming a complete digital 3-dimensional model of the object. For example, a 3-dimensional scanning system can form a 3-dimensional model using imaging cameras that record images of the object. However, as the system may model the portion of the object that is in direct line-of-sight with the imaging cameras, the object may be imaged from multiple different angles to form a complete 3-dimensional model. The object can imaged multiple times and rotated by a number of degrees between each imaging. This allows the system to have a 360° view of the object to form a 3-dimensional model of all sides of the object.

In systems that use imaging cameras located above the object to be scanned, defects can sometimes remain in the 3-dimensional model of the object when portions of the object are not visible to the imaging cameras even when the object is rotated to multiple different rotational positions. Therefore, the system can also allow for the object to be tilted. Tilting the object by a number of degrees can give the imaging cameras a more direct view of the sides of the object and eliminate the “shadows” that can interfere with forming a complete 3-dimensional model of the object.

Some 3-dimensional scanning systems may rotate and/or tilt the object to be scanned in an automated manner. These systems can include a rotatable and tiltable scanning platform that allows the object to be rotated and tilted to all necessary positions for scanning the object without requiring a human operator to manually reposition the object. However, automated systems for rotating and tilting an object can create a risk of the object sliding or falling over during rotations and tilting. As an example, solutions involve anchoring the object to the rotating and tilting scanning platform using a temporary adhesive. In some examples, an adhesive putty can be used to adhere the object to the platform. However, in some systems the rotating and tilting scanning platform can have a surface formed of a silicone rubber material, which tends to adhere poorly to adhesive putty. Accordingly, the present disclosure describes scanning platforms that have enhanced adhesion to adhesive putty. This can allow the system to scan larger, heavier objects and tilt the objects at steeper angles without causing the objects to slide or fall over.

In some examples of the present technology, a scanning platform can include an upper portion formed of a silicone polymer providing a silicone polymer upper surface. Thus, the upper portion includes a silicone upper surface that can be chemically activated using a corona treatment, which can increase the surface energy of the silicone surface and create reactive groups on the surface such as hydroxyl, carboxyl, and carbonyl groups. The surface can also have a layer of an adhesion promoting compound applied to the surface. This layer can be chemically bonded to the surface, and/or bonded to the surface through hydrogen bonding. The adhesion promoting compound can include a glycol, glycol ether, or combinations thereof. In some cases the adhesion promoting compound can be a compound that would not readily react with the silicone surface without the corona treatment. After this surface treatment, the platform can have increased tack so that adhesive putty will stick to the surface more strongly than to an untreated silicone surface.

The term “upper portion” and “upper surface” can be used to describe the same structure or a portion of the same structure. For example, a silicone upper portion refers to an upper section of, or material attached to, the platform; and the upper surface of the upper portion refers to an exposed surface of the upper portion. Thus, discussions of each structure or surface can be somewhat interchangeable, depending on the context.

It is noted that, as used in this specification and the appended claims, the singular forms “a,” “an,” and “the” include plural referents unless the content clearly dictates otherwise.

In further examples, a scanning platform can be supported by and positioned above a base portion. In one example, the base portion is also attached to the scanning platform. The scanning platform can be rotatable and/or tiltable with respect to the base portion. This can allow objects on the scanning platform to be rotated and/or tilted during 3-dimensional scanning.

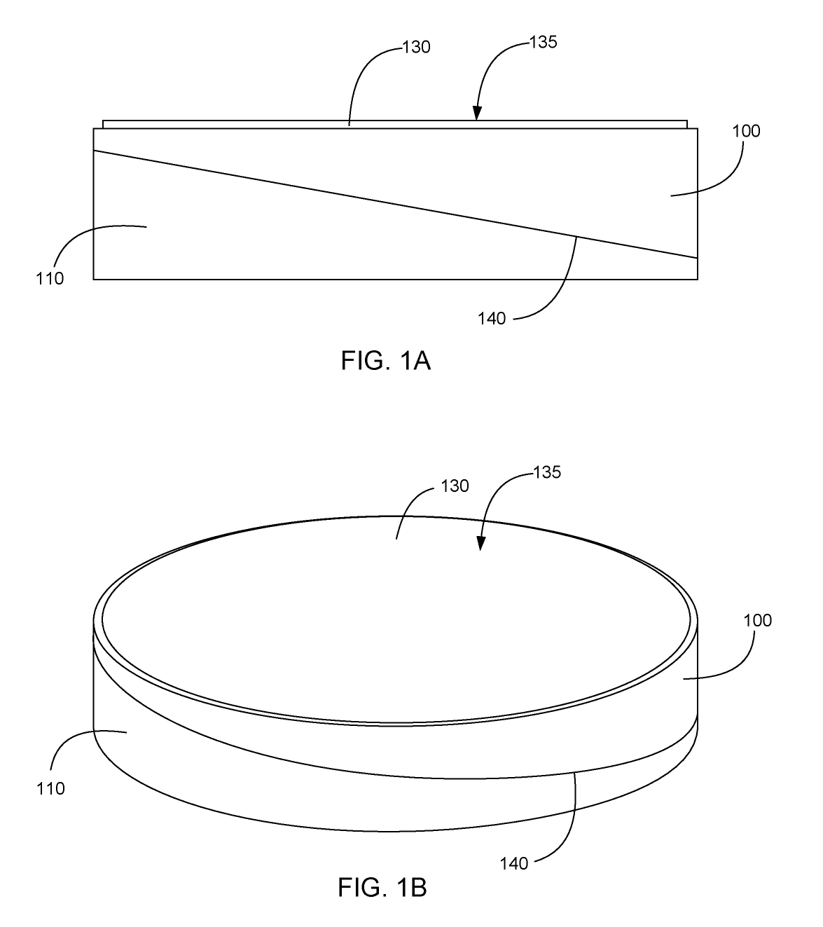

One example of a scanning platform is shown in FIGS. 1A and 1B. FIG. 1A shows a side view of a scanning platform 100. The scanning platform is supported by and positioned above a base portion 110. The scanning platform includes a silicone upper portion 130 at the top of the scanning platform having a silicone upper surface 135. The base portion and scanning platform are attached at a slanted rotatable joint 140 which allows the scanning platform to rotate and tilt with respect to the base portion.

FIG. 1B shows a perspective view of the scanning platform 100 which can be supported by and positioned above a base portion 110. In one example, the base portion is attached to the scanning platform. The scanning platform includes the silicone upper portion 130 having the silicone upper surface 135, and slanted rotatable joint 140. In this particular example of the technology, the scanning platform has a circular shape when viewed from above. However, any shape of scanning platform can be used.

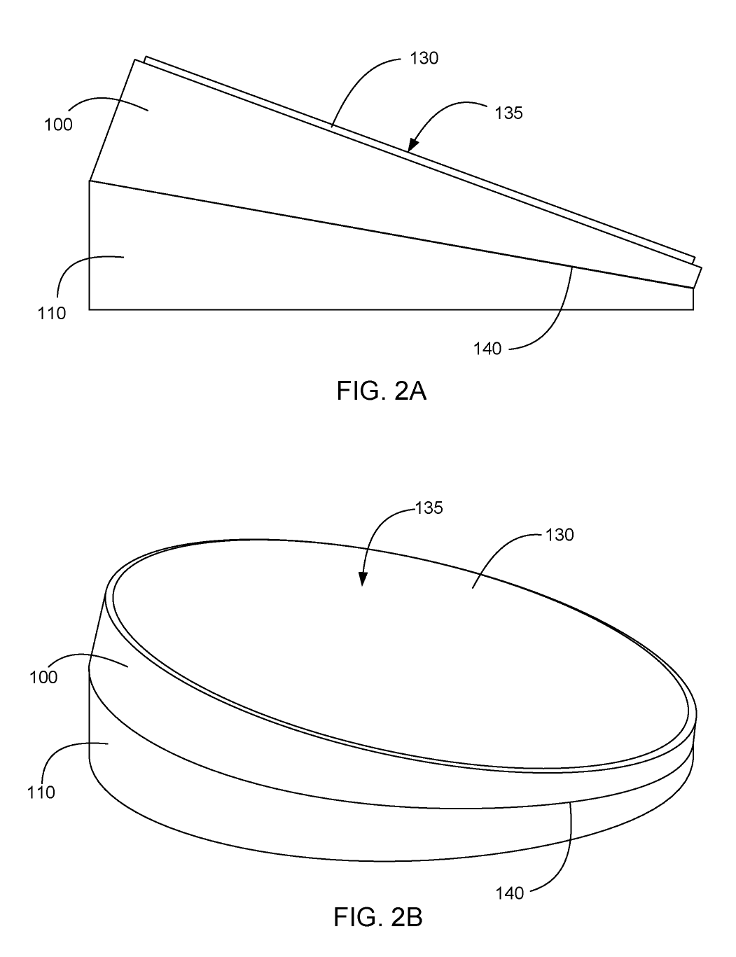

FIG. 2A shows a side view and FIG. 2B shows a perspective view of the scanning platform 100 when the scanning platform has been rotated. Because the slanted rotatable joint 140 is at an angle with respect to the bottom of the base portion 110, when the scanning platform is rotated, the upper portion 130 (and upper surface 135) of the scanning platform also becomes tilted with respect to the base portion. In some examples, the base portion can be independently rotatable so that the base portion can rotate with respect to a table, desk, or other surface on which the base portion is resting. By rotating the base portion relative to the scanning platform, an object on the scanning platform can be oriented in a variety of rotational and tilt positions.

The example shown in FIGS. 1A, 1B, 2A, and 2B uses a circular scanning platform and base portion with a slanted rotatable joint to allow the scanning platform to be rotatable and tiltable with respect to the base portion. However, many other shapes and/or configurations of various scanning platforms can also be used. For example, a variety of mechanisms can allow the scanning platform to rotate and/or tilt with respect to the base portion. The scanning platform can also have any shape besides the circular shape shown in the figures.

In some examples, the scanning platform and/or base portion can include motors or other actuators for rotating and/or tilting the scanning platform. In one example, a first motor may rotate the base portion and a second motor may rotate the scanning platform. In a further example, the motors can be internal motors located inside the base portion and/or scanning platform.

A controller can be used to electronically control the rotation and tilting of the scanning platform. In certain examples a computer can be in communication with the scanning platform through a wired or wireless connection. The computer can also be in communication with imaging cameras or other sensors used for scanning objects on the scanning platform. In one example, the computer may automatically rotate and tilt the scanning platform to a sufficient number of positions so that a complete digital 3-dimensional model of the object can be formed. Thus, the 3-dimensional scanning process can be completely automated. However, in some cases a human operator can also manually reposition the object one or more times in order to form a complete model of the object. In one example, an object can be manually placed on the scanning platform so that the base of the object rests on the scanning platform. Then, the computer can automatically position the object in a series of different positions and record images of the object using imaging cameras in each position. Then, the object can be manually placed on the scanning platform so that a side of the object rests on the scanning platform. The computer can then repeat the process of positioning the object and recording images of the object. After completing this process, the computer can process all of the images of the object in all the different positions to form a 3-dimensional model of the entire object. Thus, in some examples a full 3-dimensional model can be formed while manually repositioning the object once.

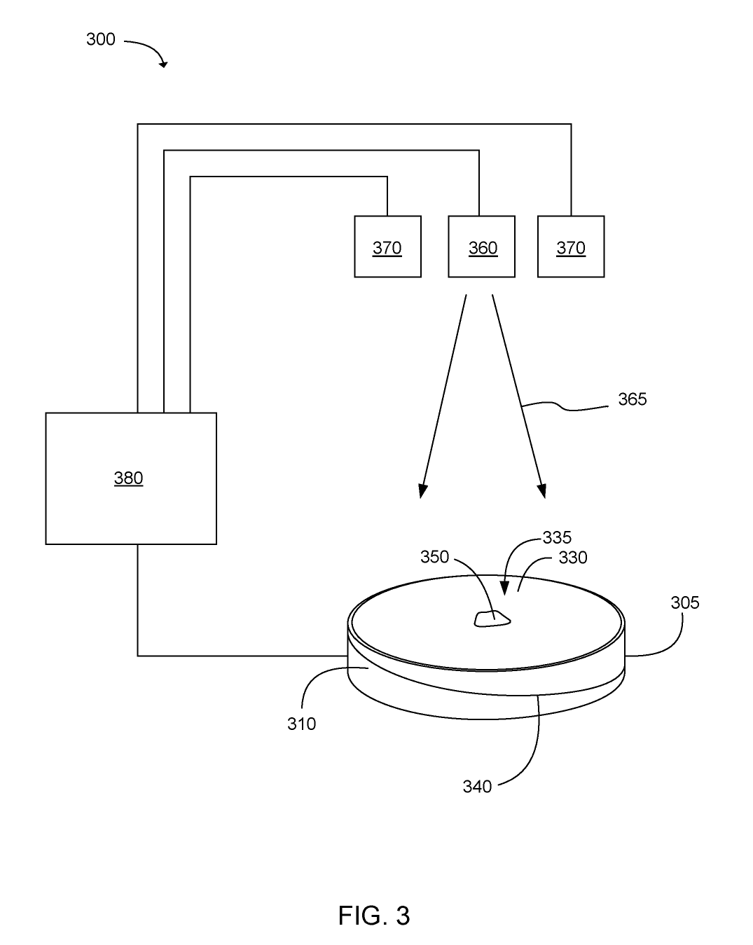

FIG. 3 shows an example of a system 300 including a scanning platform 305 which can be supported by and positioned above a base portion 310. The scanning platform includes a silicone upper portion 330 having a silicone exposed upper surface 335. The base portion and scanning platform are attached at a slanted rotatable joint 340. The scanning platform is also shown with a small quantity of adhesive putty 350 on the silicone upper portion. The system also includes a pattern projector 360 to project a light pattern 365 onto an object to be scanned on the scanning platform, and a plurality of imagers 370 to record digital images of light reflected from the object to be scanned on the scanning platform. A controller 380 is in communication with the scanning platform, pattern projector, and plurality of imagers. The controller may rotate and/or tilt the scanning platform and to form a digital 3-dimensional model of the object to be scanned based on the digital images formed by the plurality of imagers.

The pattern projector can project a light pattern that aids in the conversion of images recorded by the imagers to a digital 3-dimensional model. In various examples, the light pattern can be plain white or monochromatic light, infrared light, or another wavelength of light. In further examples, the light pattern can include dots, vertical bars, horizontal bars, checkboard patterns, rings, or other contrasting patterns of light and dark or multiple colors of light. The controller can analyze images recorded by the imagers and compare the original light pattern with distortions in the pattern caused by the shape of the object being scanned. By using imagers that view the object from a different angle than the pattern projector, the controller can extract information about the 3-dimensional shape of the object from the distortions in the light pattern. In some examples, the pattern projector can be a LCD projector, DLP projector, laser projector, or other type of projector capable of projecting a light pattern.

The imagers can be any type of imager capable of recording images of the wavelengths of light projected by the pattern projector. For example, the imagers can include imaging cameras for recording visible light and/or infrared cameras for recording infrared light. In some examples, a combination of visible light and infrared imagers can be used. The pattern projector can also include multiple projectors that project multiple wavelengths of light. For example, the pattern projector can include a visible light projector and an infrared projector. The light patterns projected using visible and infrared light can be recorded by a visible light camera and an infrared camera.

As mentioned above, scanning platforms that include an untreated silicone surface (which is a top/exposed surface of the silicone upper portion) can be somewhat slippery and the object being scanned can slide or fall when the scanning platform is rotated and tilted during scanning. Therefore, adhesive putty can be used to secure the object to the scanning platform surface. The present technology provides a silicone scanning platform surface that is treated to increase the adhesion between the surface and the adhesive putty, so that the object being scanned can be even more secure. This can allow for the scanning of heavier and taller objects using steeper tilt angles.

The silicon polymer surface of the scanning platform can be treated to increase its adhesion. In some examples, the surface of the upper portion can be treated by a corona discharge to chemically activate the surface. The corona discharge can increase the surface energy of the silicone surface and create reactive groups such as hydroxyls, carboxyls, and carbonyls on the silicone surface. The chemically activated surface can then be treated with an adhesion promoting compound that forms a layer on the surface. In certain examples, the adhesion promoting compound can chemically bond or hydrogen bond to the surface. In further examples, the adhesion promoting compound can include a glycol, glycol ether, or combinations thereof.

Treating the silicone surface in this way may form a layer of the adhesion promoting compound bonded to the silicone surface, which increases the tackiness or adhesion of the surface. The treated surface can become tackier in general, and in particular the adhesion between the surface and adhesive putties can be increased.

The silicone surface of the platform can include polymers such as polysiloxanes. In some examples, the silicone surface can include a polysiloxane made up of monomers such as dimethyl siloxane, methylhydrogen siloxane, alkylmethyl siloxane, 3-aminopropyl methyl siloxane, diphenyl siloxane, 3-hydroxypropyl methyl siloxane, methylphenyl siloxane, stearoyloxyalkyl siloxane, vinyl siloxane, and combinations thereof.

The adhesive putty can be a variety of commercially available adhesive putties, often referred to as “sticky tack” and by other generic or trademarked names. The adhesive putty can be removable and reusable. Non-limiting specific examples of adhesive putty that can be used include Scotch® MMM860 Removable Adhesive Putty, Elmer's® Poster Tack, Duck® Poster Putty, Loctite® Fun-Tak® Mounting Putty, Bostik® Blu-Tack® Reusable Adhesive, BüroFix™ adhesive putty from Gutenberg, and other adhesive putties.

Adhesion between the silicone surface of the scanning platform and the adhesive putty can be increased by forming a layer of an adhesion promoting compound on the silicone surface. The adhesion promoting compound acts as a primer that strongly interacts with the silicone surface, and also interacts with the adhesive putty to increase adhesion. In some examples, the adhesion promoting compound can include a glycol, a glycol ether, or combinations thereof. The glycol or glycol ether can include aliphatic glycol ethers, aromatic glycol ethers, or combinations thereof. In certain examples, the adhesion promoting compound can include ethylene glycol, ethylene glycol monomethyl ether, diethylene glycol, diethylene glycol monomethyl ether, triethylene glycol, triethylene glycol monomethyl ether, propylene glycol, propylene glycol monomethyl ether, dipropylene glycol, dipropylene glycol monomethyl ether, tripropylene glycol, tripropylene glycol monomethyl ether, and combinations thereof. In further examples, the adhesion promoting compound can be a glycol or glycol ether having a molecular weight from about 62 g/mol to about 200 g/mol.

As used herein, the term “about” is used to provide flexibility to a numerical range endpoint by providing that a given value may be “a little above” or “a little below” the endpoint. The degree of flexibility of this term can be dictated by the particular variable and can be determined based on experience and the associated description herein.

In certain examples, the adhesion promoting compound can further include an isocyanate, poly-isocyanate, or combination thereof. The isocyanate or poly-isocyanate can be aliphatic or aromatic. Non-limiting specific examples of isocyanates and poly-isocyanates include hexamethylene diisocyanate (HDI), methylene diphenyl diisocyanate (MDI), toluene diisocyanate (TDI), and polymeric versions thereof. In some examples, the adhesion promoting compound can include isocyanates and/or poly-isocyanates that react with glycols and/or glycol ethers to from a polyurethane coating chemically bonded to the silicone surface.

In some examples, the adhesion promoting compound can be chemically bonded to the chemically activated silicone surface of the scanning platform. For example, the chemically activated silicone surface can include hydroxyl groups, carboxyl groups, carbonyl groups, or combinations thereof and the adhesion promoting compound can react with these groups to become chemically bonded to the surface. Hydroxyl groups and/or isocyanate groups of the adhesion promoting compound can undergo a reaction with the reactive groups on the silicone surface, bonding the adhesion promoting compound to the surface. In certain examples, the adhesion promoting compound can be bonded to the surface through ether linkages, ester linkages, urethane linkages, or combinations thereof. In other examples, the adhesion promoting compound can be bonded to the surface through hydrogen bonding. In additional examples, the adhesion promoting compound can form a layer on the silicone surface that is substantially one molecule thick.

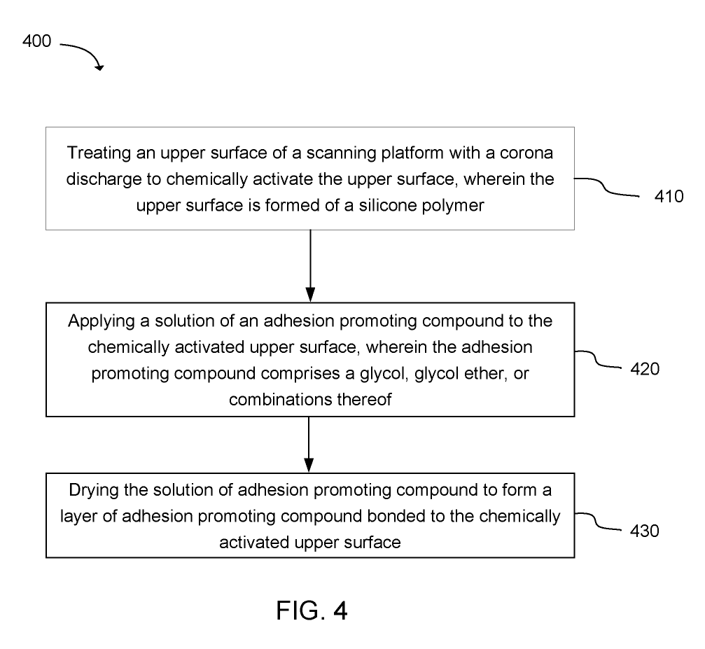

The present technology also extends to methods of providing adhesion to scanning platforms. FIG. 4 is a flowchart of one example of a method 400 including treating 410 an upper surface of a scanning platform with a corona discharge to chemically activate the upper surface, wherein the upper surface is formed of a silicone polymer; applying 420 a solution of an adhesion promoting compound to the chemically activated upper surface, wherein the adhesion promoting compound includes a glycol, glycol ether, or combinations thereof; and drying 430 the solution of adhesion promoting compound to form a layer of adhesion promoting compound bonded to the chemically activated upper surface.

The corona discharge treatment can be performed in ambient air. No special atmosphere is required for the corona treatment of the silicone surface, and no dangerous byproducts are produced during the corona treatment. Therefore, the corona treatment can be performed in the open air without requiring any special safety precautions such as vent hoods or enclosed chambers.

The corona treatment can include exposing the silicone surface to a corona discharge at a frequency of 15 kHz to 10 MHz, a voltage of 10 kV to 80 kV, for a time period of 5 seconds to 60 seconds. In certain examples, the corona treatment can be an atmospheric plasma treatment and can be performed at 4 MHz to 5 MHz, with a voltage of 10 kV to 48 kV, for a time period of about 15 seconds. In further examples, a flame or chemical plasma corona treatment can be used.

After the corona treatment, the solution of adhesion promoting compound can be applied while the silicone surface remains chemically activated. In some examples, the solution can be applied from 0 to 30 minutes after the corona treatment. In other examples, the solution can be applied from 0 to 15 minutes after the corona treatment.

The solution of adhesion promoting compound can be applied by any suitable method to the silicone surface. In some examples, the solution can be applied by wiping the surface with a wipe impregnated with the solution, by spraying the surface with the solution, by dipping the surface in the solution, by curtain coating, rod coating, or by any other suitable method of coating the surface.

In additional examples, the solution of adhesion promoting compound can be an aqueous solution. In some cases, the solution can be comprised of substantially only the adhesion promoting compound and water. The solution can have a water to adhesion promoting compound ratio from about 1:1 to about 20:1 by weight. In certain examples, the solution can have a water to adhesion promoting compound ratio from about 1:1 to about 10:1 by weight.

After the solution of adhesion promoting compound is applied, the solution can be allowed to dry. The drying time can be sufficient to leave a substantially dry layer of adhesion promoting compound bonded to the silicone surface of the platform. In some examples, the solution can be allowed to dry at ambient conditions for 5 to 10 minutes. In other examples, a drying oven, drying blower, or other such equipment can be used to speed the drying of the solution.

Because the solution of adhesion promoting compound contains chemicals that are considered safe, the solution can be applied without special protective equipment. Similarly, the solution does not give off any harmful vapors during drying, so no special ventilation equipment is needed. In one example, the solution of adhesion promoting compound can be applied by a human operator wearing gloves and eye protection as standard protective equipment. After the application, the solution can be allowed to air dry at ambient conditions.

As explained above, the adhesion promoting compound can form a layer bonded to the silicone surface of the platform. This layer increases the tack of the silicone surface. In particular, the layer of adhesion promoting compound can increase the adhesion of adhesive putties on the silicone surface. The layer of adhesion promoting compound can be substantially permanent. Thus, the corona treatment and application of the adhesion promoting compound can be performed once at the time of manufacture of the scanning platform, and then the scanning platform can exhibit increased tack over its entire useful lifetime.

In another example of the method for providing adhesion to a scanning platform, the method can further include adhering an object to be scanned to the silicone upper surface of the upper portion using an adhesive putty. The adhesive putty can adhere to the silicone surface more strongly than the adhesive putty would adhere to an identical silicone surface without the corona treatment and application of the adhesion promoting compound. In some examples, the adhesion of the adhesive putty to the upper portion of the scanning platform can be at least 2 times stronger compared to an identical silicone polymer surface that has not been treated with the corona discharge and adhesion promoting compound. In further examples, the adhesion of the adhesive putty can be 2 to 10 times stronger, or 5 to 7 times stronger compared to adhesion to an identical silicone polymer surface that has not been treated with the corona discharge and adhesion promoting compound.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight ratio range of about 1 wt % to about 20 wt % should be interpreted to include not only the explicitly recited limits of 1 wt % and about 20 wt %, but also to include individual weights such as 2 wt %, 11 wt %, 14 wt %, and sub-ranges such as 10 wt % to 20 wt %, 5 wt % to 15 wt %, etc.

The following example illustrates a method of providing adhesion to a scanning platform according to the present technology. However, it is to be understood that this example is only exemplary or illustrative of the application of the principles of the present compositions, media, and methods. Numerous modifications and alternative compositions, media, and methods may be devised without departing from the spirit and scope of the present disclosure. The appended claims are intended to cover such modifications and arrangements. Thus, while the technology has been described with particularity, the following example provides further detail in connection with the present technology.

### Example

A scanning platform was manufactured having a silicone upper portion. The total area of the silicone surface on the upper portion was 30,000 mm². The silicone surface was treated with an ambient corona discharge operating at 5 MHz and 5 kV with a 25 mm diameter head. The corona treatment was applied to the silicone surface evenly over 120 seconds. Within 15 minutes of the corona treatment, an operator wiped the silicone surface with a lint-free wipe impregnated with a 10:1 solution of water and dipropylene glycol monomethyl ether. The treated surface was allowed to dry for 5 minutes at 20° C. at 50% relative humidity.

After drying, the surface was tested for adhesion to BüroFix™ adhesive putty from Gutenberg. The adhesion was tested by adhering a 0.6 g sample of the putty to the surface and pulling vertically on the putty until the putty was released from the surface. The treated surface adhered to the putty until 0.35 kg of force was applied. The surface was also tested before the treatment, and the untreated surface only adhered to the putty until 0.07 kg of force was applied. Thus, the corona treatment and application of the dipropylene glycol monomethyl ether increased the adhesion of the surface by a factor of 5. The adhesion test was repeated on the treated surface over 1,000 times without any observable reduction in adhesion, indicating that the treatment provides adhesion to the surface.

While the disclosure has been described with reference to certain examples, various modifications, changes, omissions, and substitutions can be made without departing from the spirit of the disclosure. It is intended, therefore, that the disclosure be limited only by the scope of the following claims.

What is claimed is:

1. A scanning platform, comprising:
an upper portion formed of a silicone polymer, wherein an upper surface of the upper portion is chemically activated by a corona treatment; and
a layer of an adhesion promoting compound bonded to the upper surface, wherein the adhesion promoting compound comprises a glycol, glycol ether, or combinations thereof.

2. The scanning platform according to claim 1, wherein the scanning platform is supported by and positioned above a base portion.

3. The scanning platform according to claim 2, wherein the scanning platform is rotatable with respect to the base portion.

4. The scanning platform according to claim 2, wherein the scanning platform is tiltable with respect to the base portion.

5. The scanning platform according to claim 2, wherein the scanning platform is rotatable and tiltable with respect to the base portion, and further comprising a controller in communication with the platform to rotate and tilt the platform.

6. The scanning platform according to claim 1, further comprising an adhesive putty adhered to the scanning platform.

7. The scanning platform according to claim 1, wherein the chemically activated upper surface includes hydroxyl groups, carboxyl groups, carbonyl groups, or combinations thereof such that the adhesion promoting compound is chemically bonded to the surface through ether linkages, ester linkages, urethane linkages, or combinations thereof.

8. The scanning platform according to claim 1, wherein the adhesion promoting compound comprises ethylene glycol, ethylene glycol monomethyl ether, diethylene glycol, diethylene glycol monomethyl ether, triethylene glycol, triethylene glycol monomethyl ether, propylene glycol, propylene glycol monomethyl ether, dipropylene glycol, dipropylene glycol monomethyl ether, tripropylene glycol, tripropylene glycol monomethyl ether, or combinations thereof.

9. The scanning platform according to claim 1, wherein the adhesion promoting compound further comprises an isocyanate, a poly-isocyanate, or combinations thereof.

10. A method, comprising:
treating an upper surface of a scanning platform with a corona discharge to chemically activate the upper surface, wherein the upper surface is formed of a silicone polymer;
applying a solution of an adhesion promoting compound to the chemically activated upper surface, wherein the adhesion promoting compound is a glycol, glycol ether, or combinations thereof; and
drying the solution of the adhesion promoting compound to form a layer of the adhesion promoting compound bonded to the chemically activated upper surface.

11. The method of claim 10, wherein the solution of the adhesion promoting compound is applied within 15 minutes after treating the upper surface with the corona discharge.

12. The method according to claim 10, wherein the solution of the adhesion promoting compound is an aqueous solution.

13. The method according to claim 10, wherein the solution of the adhesion promoting compound is an aqueous solution comprising ethylene glycol, ethylene glycol monomethyl ether, diethylene glycol, diethylene glycol monomethyl ether, triethylene glycol, triethylene glycol monomethyl ether, propylene glycol, propylene glycol monomethyl ether, dipropylene glycol, dipropylene glycol monomethyl ether, tripropylene glycol, tripropylene glycol monomethyl ether, or combinations thereof.

14. The method according to claim 10, wherein the adhesion promoting compound further comprises an isocyanate, a poly-isocyanate, or combinations thereof.

15. The method according to claim 10, further comprising adhering an object to be scanned to the upper surface using an adhesive putty.

16. The method according to claim 15, wherein the adhesion of the adhesive putty to the upper surface is from about 2 to about 10 times stronger compared to an identical silicone polymer surface that has not been treated with the corona discharge and adhesion promoting compound.

17. A system, comprising:
a scanning platform comprising:
an upper portion formed of a silicone polymer, wherein the upper portion includes an upper surface that is chemically activated by a corona treatment, and
a layer of an adhesion promoting compound bonded to the chemically activated upper surface, wherein the adhesion promoting compound comprises a glycol, glycol ether, or combinations thereof;
a base portion, wherein the scanning platform is supported by and positioned above the base portion;
a pattern projector to project a light pattern onto an object to be scanned on the scanning platform;
a plurality of imagers to record digital images of light reflected from the object to be scanned on the platform; and
a controller in communication with the scanning platform, pattern projector, and plurality of imagers, wherein the controller is to rotate the platform and form a digital 3-dimensional model of the object to be scanned based on the digital images formed by the plurality of imagers.

18. The system according to claim 17, wherein the adhesion promoting compound further comprises an isocyanate, a poly-isocyanate, or combinations thereof.

19. The system according to claim 17, wherein the scanning platform is tiltable with respect to the base portion

20. The system according to claim 17, further comprising an adhesive putty adhered to the scanning platform.
